(19) United States
(12) Patent Application Publication
(10) Pub. No.: US 2004/0219331 A1
(43) Pub. Date: Nov. 4, 2004

(54) Hanger label

(76) Inventors: Ulrich Moosheimer, Hohenkammer (DE); Alexander Margraf, Munchen (DE); Markus Rubekeil, Munchen (DE); Gunther Jaich, Stockdorf (DE)

Correspondence Address: WILLIAM COLLARD, COLLARD & ROE, P.C., 1077 NORTHERN BOULEVARD, ROSLYN, NY, 11576, US

(21) Appl. No.: 10/783,444

(22) Filed: Feb. 20, 2004

(30) Foreign Application Priority Data
Feb. 20, 2003 (DE) 103 07 252.7

(51) Int. Cl. B32B 3/10

(52) U.S. Cl. 428/131

(57) ABSTRACT

A hanger label (1) which is suitable in particular for hanging infusion bottles. The label (1) has a stretchable hanger (2b) and a region (2a) that can be applied to the surface (6). The stretchability of the hanger (2b) is limited in some section to prevent tearing of the hanger (2b) in critical locations, in particular at the suspension points. This improves the functional reliability of the hanger label (1).

### BACKGROUND OF THE INVENTION

1. Field of the Invention

This invention relates to a label, in particular a hanger label, having two regions, one of which can be applied to an object and the other of which can be stretched or elongated. The stretchable or extendable region serves as a hanger on which the object to which the label is applied can be hung.

2. The Prior Art

Hanger labels are used in particular for suspending infusion bottles, bags, containers, tubes, bottles for cosmetics and technical applications upside down. To make the design of such bottles or bags as simple as possible, the suspending hanger has for a long time no longer been integrated into the bag or bottle but instead is attached to the bottle or bag in the form of a label.

Such labels are known from German Patent DE 39 07 862, for example. They have a hanger section which can be unfolded from the remainder of the label which is glued to a bottle. The hanger is attached to the remainder of the label at points which are diametrically opposite one another with respect to the bottle. The hanger is thus tear-resistant so it is difficult to unfold the hanger and moreover it is only a very slightly defined hanger, which corresponds to approximately 1.5 times the diameter of the bottle to be suspended. Due to this very short hanger, a relatively high force is exerted in suspension at the points where the hanger is connected to the rest of the label.

European patent EP 0 628 321 B1 discloses a label having a hanger which is manufactured by punching a hole near the lower edge of the label. The hanger can be stretched or extended to three times its length. Due to this stretchability, vibrations could be absorbed better. This great stretching results in a great distance between the point of suspension and the bottle and thus causes the user to feel discomfort.

It is proposed in German Patent DE 195 05 531 that the hanger shall be manufactured from a stretchable or extendable material. Stretchable materials have the property that they can be stretched to a certain extent in comparison with their starting condition, and the stretched material is many times longer than it is in the initial condition. In this way the hanger of a hanger label can be lengthened greatly and thus also the risk of tearing can be reduced significantly.

Despite these advances with the known hanger labels, there are still critical regions on the hanger label which exposed to greater loads. These include, for example, the points mentioned above, where the hanger and the other label attached to the bottle are connected and in particular also the point at which the hanger is suspended on a hook, for example. When used in practice, such regions often result in the hangers being damaged here even when using stretchable hangers.

### SUMMARY OF THE INVENTION

Therefore, the object of this invention is to further improve upon the label so that a greater production certainty and an adjustable stretched length can be achieved in handling hanger labels without driving the manufacturing costs too high.

This object is achieved by a label comprising a flexible film with a first region which can be attached to a surface and a second hanger-shaped region which has tensile strength and is stretchable and preferably rests loosely on the surface, whereby the second region has means which restrict its stretchability at least in some sections. The label according to this invention achieves the result that in stretching, the hanger of the label undergoes stretching only at noncritical locations. Stretching is prevented at the critical locations. The means for restricting stretchability may be implemented in such a way that the molecular structure in the second region is modified in some sections so that stretching is impossible or is hardly possible. This may be achieved, for example, by a temperature treatment, by reaction with a chemical substance or by irradiation with light, UV, infrared, electrons and/or x-rays.

In the present invention, the term “stretching” is used to describe the process whereby the material is extended to a certain limit, and before reaching that limit, the force required to stretch the material is, relatively low. Once the limit is reached, the force required for further extending is increased abruptly. This stretching behavior is a property of the material.

The label may also be designed to comprise multiple layers, so that the means for restricting stretchability is formed by a layer of material which is applied to the second region and is not stretchable. This layer of material may be a film having tensile strength or tear-resistant film sections of a low stretchability. The film causes some parts of the second region, preferably the aforementioned the critical regions of the hanger not to be stretchable, so that the risk of tearing of the hanger is minimized or eliminated completely due to the additional reinforcement of the material in this region.

Preferably the additional layer of material applied has at least one punched line or perforation. This makes the manufacturing possible in a particularly simple manner because the layer of material can be applied to the strap over the full area. Through appropriate punched lines or perforations, the hanger is then stretchable at locations where the punched lines are created, while the stretchability of the other areas is limited by the layer of material.

The layer of material is preferably secured on the second region, for example, by adhesive. According to an advantageous embodiment, at least one adhesive neutralizing section may be formed between the layer of material and the second region, with the adhesive-neutralizing section preferably being provided in an area of the punched line or perforation. Therefore, depending on the size of this section, the rectangular part and/or the part having a restricted stretchability of the second region (hanger) may be adapted individually, so that the maximum stretched length of the hanger can be varied easily during production.

To facilitate stretching of the hanger, according to one advantageous embodiment of this invention, a gripping strap may be provided in the second region. Alternatively or additionally, a convex region is also provided in the second region, facilitating gripping of the strap in the starting state of the label dispensed onto such an object.

The first region may consist of or may partially contain polyethylene terephthalate, valerone, polyamide, oriented polypropylene or laminates and combinations of these materials.

The second region may consist of or may partially contain polybutylene terephthalate, polyethylene, valerone, polyamide, polypropylene, oriented polypropylene as well as laminates and combinations of these materials.

The stretched length of the hanger depends on the choice of materials, the thickness, the length of the free region, the width and the number of punched lines.

According to another embodiment of this invention, the second region has one or more convexities for widening the second region. Depending on the application, the stretchable region may be broadened by providing such convexities locally, in particular in the region of the punched lines in the layer of material by providing convexities to achieve a uniform thickness of the hanger in the stretched condition.

In addition, marks may be provided which indicate or delineate the stretching limit so that the user knows when the hanger has reached its maximum length. This makes it possible to prevent the hanger from undergoing elastic or even inelastic deformation due to being pulled too tightly after stretching, which would thus render it useless.

To additionally stabilize the entire label, it is possible to provide for the additional layer of material that is applied to also extend at least partially over the first region. In this way the risk of tearing can be further reduced in particular in the transitional region between the first region and the hanger.

To facilitate machine dispensing, the label is preferably designed as a self-stick label. This label preferably has a punched hanger or perforated hanger dividing the label into the first region and the second region. This facilitates dispensing because the punched or perforated portion prevents the hanger from being stretched already when it is dispensed by machine.

### BRIEF DESCRIPTION OF THE DRAWINGS

This invention and preferred embodiments are explained in greater detail below on the basis of FIGS. 1 through 5, in which:

FIG. 1a shows a view of an embodiment of the inventive hanger label in the starting state;

FIG. 1b shows the embodiment of the label from FIG. 1a in the stretched state;

FIG. 2 shows another embodiment of this invention in a frontal view;

FIG. 2a shows an enlarged detail view from FIG. 2;

FIG. 3 shows a side sectional view of an inventive label;

FIG. 4 shows a side view of an embodiment of the label on an object;

FIG. 5 shows a perspective view of the label which has been stretched and applied to an object according to this invention.

### DETAILED DESCRIPTION OF THE PREFERRED EMBODIMENTS

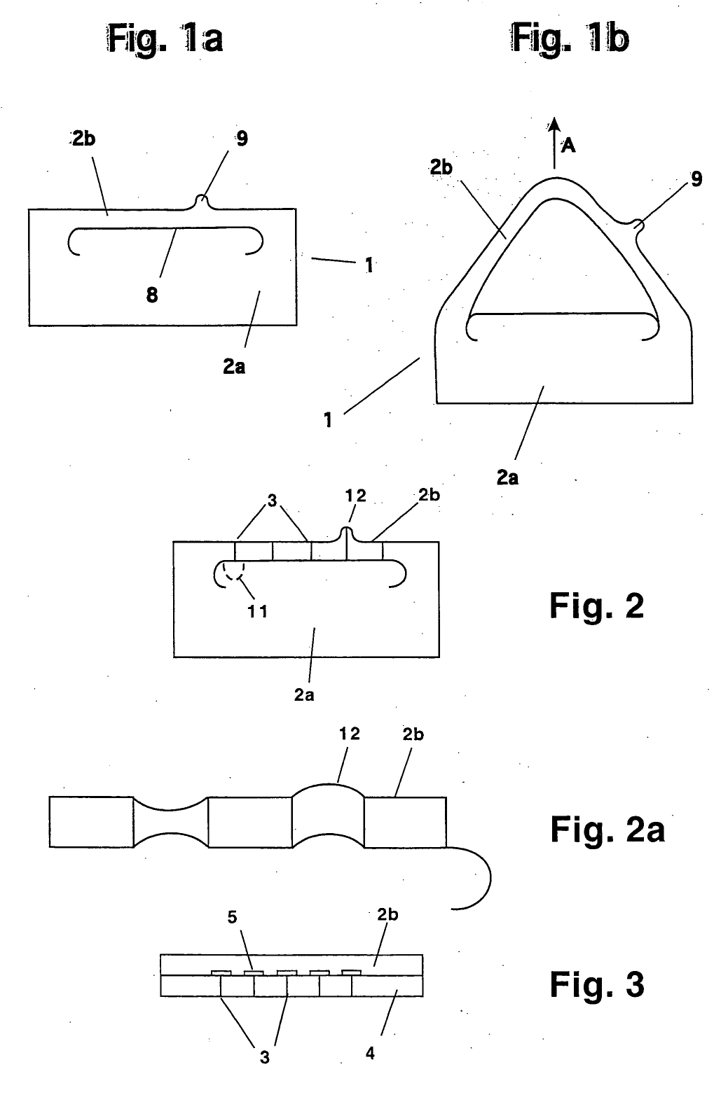

FIGS. 1a and 1b show the basic design of the inventive hanger label. The label 1 is subdivided into two regions, a first region 2a which is to be connected to an object according to this invention as intended and to a second region 2b which forms the hanger. The second region 2b is stretchable, but the critical regions (transitional region between 2a and 2b) are designed to be not stretchable. The label 1 has a punched line or perforation 8 at which the hanger 2b can be separated from the remaining label 2a. The label 1 can therefore be dispensed by machine in a compact form in the starting condition because the hanger 2b still adheres slightly to the remaining label through the punched line or perforation 8, while on the other hand, the hanger 2b can be released easily by hand and stretched after being dispensed.

This situation is diagramed in FIG. 1b. The hanger 2b is pulled in the direction of the arrow A and is therefore stretched. To facilitate the pulling and gripping on the hanger 2b, a gripping strap 9 is preferably provided on the hanger 2b. By stretching the hanger 2b, its length is increased significantly in comparison with the starting condition depicted in FIG. 1a, so that the object to which the label 1 is glued can be suspended by the hanger 2b.

To prevent excessive stretching, this is implemented section by section through appropriate limiting means. These may be-present in the stretchable material itself, for example, due to a local variation in the molecular structure which restricts stretching, or by applying a material 4 which has no stretchability or whose stretchability is limited. It may be laminated, for example, to one side of the hanger 2b or over the full region of the entire label 1.

FIG. 2 shows the first case. In the area of the hanger 2b, the material is beneath the section of the hanger 2b. Punched lines 3 (or perforations) are provided in this material. This causes the nonstretchable material to be interrupted in the area of the punched lines so that the hanger 2b is stretchable in the area of the punched lines 3 and there is little or no restriction in the other areas.

The stretchability can also be increased in the areas of the punched lines 3 for appropriate material additions 11 and 12, if necessary. Through such additional convexities 12, it is possible to compensate for the tapering of the stretched material 2b which occurs in stretching, and otherwise could lead to tearing of the hanger 2b after reaching the stretching limit under heavy loads.

The enlarged diagram in FIG. 2a shows a section of the hanger in the stretched condition, whereby the convexity 12 prevents the stretchable layer from tapering too much. At the stretching point shown at the left of FIG. 2b at which no convexity is provided, however, there is a great tapering of the stretching point.

To indicate the stretching limit, marks (not shown), for example, may be provided on the hanger. In this way the user may be warned of excessive stress on the label in hanging a bottle or the like before the hanger 2b undergoes inelastic elongation and ultimately tears.

In addition, to further secure the label 2b and to prevent tearing, means may also be provided involving the material itself, which has little or no stretchability. To do so, an additional of tear-resistant material may be provided by means of a punched line or perforation 11 in the material. This addition is accomplished by additional punched lines 11 in the area of the punched lines 3 (i.e., in the stretchable region of the hanger 2b) and it causes the hanger 2b not to tear when the stretching limit is reached in stretching of the hanger but instead it is secured by the aforementioned tear-resistant addition of tear-resistant material 4.

FIG. 3 shows a side view of another embodiment of this invention where adhesive-free regions are provided between the layer of tear-resistant material 4 and the hanger 2b which are joined together by an adhesive (not shown).

The term “adhesive-free regions” as used here and below is always to be understood as meaning that small islands of adhesive may be provided even in adhesive-free regions, thereby ensuring a temporary secure contact of the nonadhesive region with a substrate, although not unnecessarily interfering with the nonadhesive regions being released from the substrate. The adhesive islands may be in the form of strips or dots, for example, and they may consist of multiple adhesives having different adhesion properties in particular.

These adhesive-free regions may be implemented in the manufacture of the label 1 either by omitting the adhesive application in some sections or by overprinting the adhesive, which has been applied over the full area, with an adhesive killer or a siliconizing treatment in some areas. These regions 5 permit an adaptation of the rectangular regions of the hanger 2b, which is flexible in terms of the manufacturing technique, because the bonding to the material layer 4 and thus the regions that cannot be stretched at all or can be stretched only to a limited extent may be designed to be more or less large. The adhesive-free regions 5 are preferably provided in the area of the punched lines 3 to prevent the hanger from being impaired during use and with regard to stretchability due gluing of individual punched lines in the tear-resistant material layer 4.

Such a label according to FIG. 3 can be manufactured especially easily and inexpensively. To do so, first the material sheeting of a tear-resistant material 4 is punched or perforated at the stretching locations. Before or after that, an adhesive layer is applied in some sections or over the full area and is optionally neutralized (for example, by printing with another silicone layer) in some locations (in particular at the stretching locations). Then a top film of a stretchable material is laminated onto this and the hanger punching 8 is performed together with or separately from punching out the shape of the label. The labels can be printed before punching and may be finished individually or as roll goods for machine dispensing.

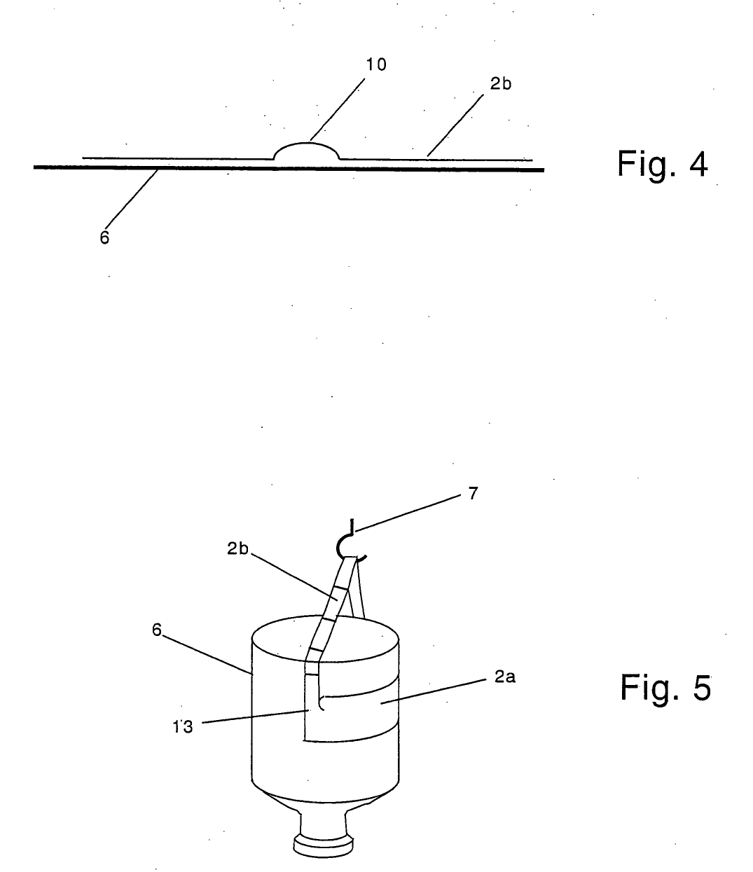

FIG. 4 shows another possible embodiment of the hanger 2b which facilitates this application. The label here is applied to a surface 6 of an infusion bottle or the like, for example. Since the hanger 2b lies flatly on the surface 6 immediately after being dispensed, it is often difficult to grip, in particular when adhesive residues, for example, cause the hanger 2b to be adhered to the surface or the hanger punched pattern 8 (see FIG. 1) may be incompletely designed, or separating it may require some pulling force (as is the case with a perforation). For this case, a convexity 10 is provided in the hanger, so that the hanger 2b is at a distance from the surface in the area of the convexity 10 and gripping of the hanger is facilitated. The convexity 10 may also be combined with a gripping tongue as mentioned above.

FIG. 5 shows an exemplary embodiment of the inventive label 1 after stretching the hanger 2b. In this case the label has been applied to a bottle 6. By stretching the hanger 2b, it can be pulled over the bottom of the bottle 6 and suspended approximately by a hook 7. The label adheres to the bottle 6 with the section 2a. The connections 13 of the hanger 2b and the rest of the label 2a are at two diametrically opposed points in the case of bottles, for example, so that the label should preferably have at least the width of half the circumference of the bottle. The suspension points 13 like the suspension point on the hanger 2b are under especially great stress on the hook 7. Therefore, at these locations in particular, a restriction on or avoidance of the stretchability of the hanger 2b should be provided, as described in detail in the above examples.

Therefore, the safety of hanger labels, in particular for infusion bottles, can be improved through the invention described here.

What is claimed is:

1. A label of a flexible film comprising
a first region (2a) which can be attached to a surface (6) and a second hanger-like region (2b) which is stretchable characterized in that the second region (2b) has means which restrict its stretchability at least in some sections.

2. The label according to claim 1, characterized in that the second hanger-like region (2b) sits loosely on the surface (6).

3. The label according to claim 1, characterized in that means for restricting the stretchability are formed by a stabile layer of material (4) applied at least to a second region (2b).

4. The label according to claim 3, characterized in that the layer of material (4) is not stretchable.

5. The label according to claim 3, characterized in that the layer of material (4) is not stretchable.

6. The label according to claim 3, characterized in that the layer of material (4) has at least one punched line or perforation (3).

7. The label according to claim 3, characterized in that the layer of material (4) is attached to the second region (2b), for example, by gluing.

8. The label according to claim 7, characterized in that at least one adhesive neutralizing section (5) is formed between the layer of material (4) and the second region (2).

9. The label according to claim 7, characterized in that the adhesive neutralizing section (5) is provided in the area of the punched line or perforation (3).

10. The label according to claim 1, characterized in that a gripping tongue (9) is formed on the second region (2b).

11. The label according to claim 1, characterized in that a convexity (10) is formed on the second region (2b).

12. The label according to claim 1, characterized in that the second region (2b) contains a material selected from the group consisting of polyethylene terephthalate, valerone, polyamide, oriented polypropylene and laminates- and combinations of these materials.

13. The label according to claim 1, characterized in that the second region (2b) contains a material selected from the group consisting of polybutylene terephthalate, polyethylene, valerone, polyamide, polypropylene, oriented polypropylene and laminates and combinations of these materials.

14. The label according to claim 1, characterized in that the second region (2b) has one or more protrusions (12) for widening the second region (2b).

15. The label according to claim 1, characterized in that marks are provided to indicate the stretching limit.

16. The label according to claim 4, characterized in that the layer of material (4) also extends at least partially over the first region (2a).

17. The label according to claim 16, characterized in that the layer of material (4) has at least one additional punched line or perforation (11) in the section of the first region (2a) adjacent to the second region (2b).

18. The label according to claim 1, characterized in that it is designed as a self-stick adhesive label.

19. The label according to claim 1, characterized in that it is subdivided into the first and second regions (2a, 2b) by a punched hanger or perforation (8).
